(19) United States
(12) Patent Application Publication
(10) Pub. No.: US 2017/0160962 A1
(43) Pub. Date: Jun. 8, 2017

(54) SYSTEM AND METHOD FOR PROCESSOR MAPPING

(71) Applicant: MediaTek Inc., Hsinchu (TW)

(72) Inventors: Shih-Yen Chiu, Hsinchu (TW); Wan-Ching Huang, Hsinchu (TW); Chung-Ho Chang, Zhubei (TW); Ya-Ting Chang, Hsinchu (TW); Ming-Ju Wu, Hsinchu (TW); Nicholas Ching Hui Tang, Zhudong (TW)

(21) Appl. No.: 15/363,181

(22) Filed: Nov. 29, 2016

Related U.S. Application Data
(60) Provisional application No. 62/262,417, filed on Dec. 3, 2015.

(51) Int. Cl. G06F 3/06

(52) U.S. Cl. CPC G06F 3/0619; G06F 3/065; G06F 3/067

(57) ABSTRACT

A multicore processor system includes multiple processor cores. When a processor core goes offline, the offline processor core is mapped to a mapped processor core, which is selected from an emulated processor core and one or more online processor cores among the multiple processor cores. The emulated processor core is a software construct containing an emulated state of the offline processor core. When the multicore processor system receives a system call that is sent from a requestor to the offline processor core to request for system information from the offline processor core, the system call is re-directed to the mapped processor core. The system information is returned from the mapped processor core to the requestor in response to the system call.

### CROSS-REFERENCE TO RELATED APPLICATIONS

This application claims the benefit of U.S. Provisional Application No. 62/262,417 filed on Dec. 3, 2015.

### TECHNICAL FIELD

Embodiments of the invention relate to the management of processor cores in a multicore processor system.

### BACKGROUND

Most modern computing systems provide hot-plug support that allows a processor core to be powered on or off, or physically inserted or removed, during operating system (OS) runtime without restarting the system. In a multicore processor system that supports hot-plug, the OS can unplug a processor core to remove it from the system and can replug it back into the system on demand, without the processor core being physically unplugged or re-plugged. A hot-pluggable system is adaptable to the changing capacity demand, as processor cores can be dynamically provisioned on demand. Moreover, for system reliability purposes, a hot-pluggable system can remove a faulty processor core during OS runtime, keeping the processor core off the system execution path.

When a processor core is hot-plugged from a system, the processor core is offline from the OS kernel's standpoint, and a part or all of its file system is removed. Typically, in a multicore processor system, one of the processor core is designated as a default keeper of system information. For example, a user space application may send an inquiry to the default processor core to find out an operating status of the system. A problem arises when the default processor core is offline, e.g., hot-plugged, from the system. Some user space applications may be unaware of the offline state of the default processor core, and may continue to send inquiries to the default processor core. The responses, if any, to such inquiries are unreliable and unpredictable. Therefore, there is a need for providing reliable system information in response to inquiries when the inquiries are sent to an offline processor core in a multicore processor system.

### SUMMARY

In one embodiment, a method is provided for mapping processor cores in a multicore system that includes a plurality of processor cores. The method comprises: detecting that an offline processor core is present among the plurality of processor cores; mapping the offline processor core to a mapped processor core, which is selected from an emulated processor core and one or more online processor cores among the plurality of processor cores, wherein the emulated processor core is a software construct containing an emulated state of the offline processor core; re-directing a system call to the mapped processor core, wherein the system call is sent from a requestor to the offline processor core to request for system information from the offline processor core; and returning the system information from the mapped processor core to the requestor in response to the system call.

In another embodiment, a system includes a plurality of processor cores and memory. The memory contains instructions executable by the plurality of processor cores. The system is operative to detect that an offline processor core is present among the plurality of processor cores; map the offline processor core to a mapped processor core, which is selected from an emulated processor core and one or more online processor cores among the plurality of processor cores, wherein the emulated processor core is a software construct containing an emulated state of the offline processor core; re-direct a system call to the mapped processor core, wherein the system call is sent from a requestor to the offline processor core to request for system information from the offline processor core; and return the system information from the mapped processor core to the requestor in response to the system call.

According to embodiments described herein, a multicore processor system provides a mapping of processor cores such that a request for system information can be made to an offline processor core.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates a multicore processor system according to one embodiment.

FIG. 2A and FIG. 2B illustrate two alternative mappings of an offline processor core according to some embodiments.

FIG. 3A and FIG. 3B illustrate two other mappings of an offline processor core according to some embodiments.

FIG. 4 illustrates an alias manager according to one embodiment.

FIG. 5 illustrates an interceptor of system calls according to one embodiment.

FIG. 6 is a flow diagram illustrating a method for managing an alias of an offline processor core according to one embodiment.

FIG. 7 is a flow diagram illustrating a method for mapping an offline processor core according to one embodiment.

### DETAILED DESCRIPTION

In the following description, numerous specific details are set forth. However, it is understood that embodiments of the invention may be practiced without these specific details. In other instances, well-known circuits, structures and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

It should be noted that the term “multicore processor system” as used herein may be arranged and managed as one or more clusters. A multicore processor system may be a multicore system, a multi-processor system, or a combination of both, depending upon the system implementation. In other words, the proposed method may be applicable to any multicore system and multi-processor system arranged and managed as one or more clusters. A “processor core” as used herein may be a core, a processor, a central processing unit (CPU), a graphics processing unit (GPU), or a processing element of any kind. A “cluster” as used herein may be a group of cores, processors, CPUs, GPUs or processing elements of any kind.

Furthermore, a processor core is offline when it is deactivated from the OS kernel's standpoint. That is, an offline processor core is removed from a list of processor cores which receive task assignments from a task scheduler. An offline processor core is in a power-off state or an ultra-low power state. A processor core in the ultra-low power state receives just enough power to retain data in its caches but not enough to afford logical calculations. A non-limiting example of an offline processor core is a processor core that is hot-plugged (i.e., unplugged) from a system. A processor core is online when it is activated from the OS kernel's standpoint. That is, an online processor is responsive to inquiries and task assignments. An online processor core may be actively executing tasks, or is ready for task assignments if it has not yet received a task assignment. An online processor core is in a power-on state.

In the following description, the term “processor core,” unless specified otherwise, refers to a physical processor core in the multicore processor system. A “logical processor core” refers to a logical or virtual entity receiving task assignments for execution, but the actual execution is performed on a physical processor core to which the logical processor core is mapped. The term “emulated processor core” refers to a software construct that includes a set of data structures to store the emulated state of one or more offline processor cores. The term “active processor core” refers to an online processor core (which is also a physical processor core) that is in active operation.

Embodiments of the invention provide a system and method for mapping an offline processor core to another processor core (referred to as a “mapped processor core”) in a multicore processor system. The mapped processor core may be an online processor core, an active processor core or an emulated processor core. The offline processor core may be any of the processor cores in the multicore processor system. In one embodiment, the offline processor core may be the default processor core that keeps system information and exports system information to user space applications upon request.

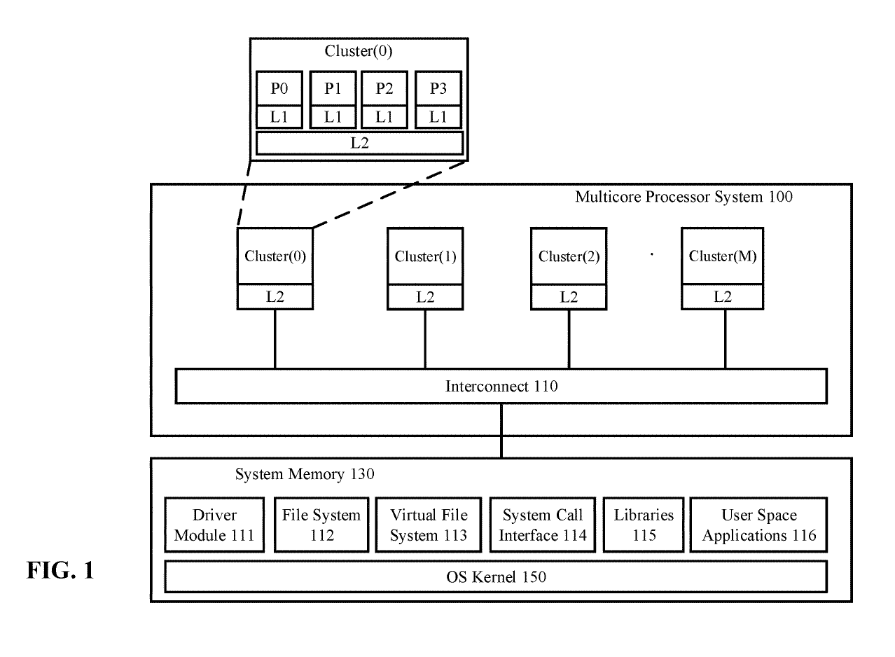

FIG. 1 illustrates an example of a multicore processor system 100 according to one embodiment. In this example, the multicore processor system 100 includes multiple clusters of processor cores: Cluster(0), Cluster(1), . . . , Cluster(M). In alternative embodiments, the multicore processor system 100 may include any number of clusters that is at least one. Each cluster includes one or more processor cores, which may be of identical processor types or different processor types. As used herein, a “processor type” refers to common characteristics shared by a group of processor cores, where the common characteristics include, but are not limited to, power consumption characteristics and computation performance. As an example, Cluster(0) is shown on top of FIG. 1 as including four processor cores P0-P3.

In one embodiment, the multicore processor system 100 includes a multi-level cache structure. For example, each processor core may include or has exclusive access to an L1 cache, and processor cores of the same cluster may share the same L2 cache or additional levels of caches. In another embodiment, each processor core may include or has exclusive access to an L1 cache and an L2 cache, and processor cores of the same cluster may share the same L3 cache or additional levels of caches. It is noted that in further other embodiments, each processor core may include or has exclusive access to one or more caches, and processor cores of the same cluster may share additional one or more caches. In addition to the shared cache(s), processor cores of the same cluster may share other hardware components such as a memory interface, timing circuitry, and other shared circuitry. Processor cores in each cluster also have access to a system memory 130 via an interconnect 110.

In one embodiment, the system memory 130 stores an OS kernel 150 containing instructions executable by the multicore processor system 100 for managing system resources. The OS kernel 150 includes, controls or manages a number of software modules, such as a driver module 111, a file system 112, a virtual file system 113, a system call interface 114, libraries 115, and user space applications 116. The driver module 111 may include a dynamic voltage frequency scaling (DVFS) driver, which dynamically adjusts the operating voltage and frequency of each processor core to manage power and performance of the processor core. The file system 112 provides data structures for the OS kernel 150 to store code and data, as well as keeping track of system resources and files. The virtual file system 113 provides an abstract layer on top of the file system 112 to facilitate access to different types of file systems. In an embodiment where the OS kernel 150 is a Linux® kernel, the file system 112 may include sysfs, which stores system information about various kernel subsystems, hardware devices, and associated device drivers. The system call interface 114 handles the communications between the user space and the system components. The libraries 115 includes a standard library, which provides constructs, routines and definitions for programming languages such as the C programming language and/or other programming languages. The user space applications 116, when executed by any of the processor cores, may call directly or indirectly the libraries 115, the system call interface 114 and the virtual file system 113 to access system utilities and system information.

In one embodiment, the software modules 111-116 may be stored in the system memory 130 or other non-transitory computer readable medium accessible by the multicore processor system 100. The software modules 111-116 may be executed by any of the processor cores in the multicore processor system 100. It is understood that the OS kernel 150 may include, control or manage additional or alternative software modules that are not shown in FIG. 1.

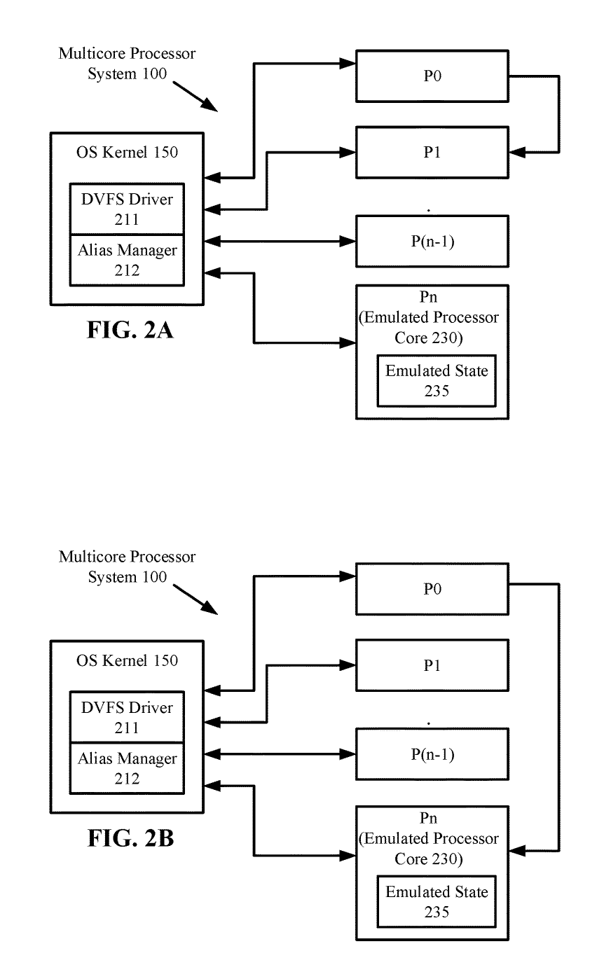

FIG. 2A and FIG. 2B illustrate two alternative mappings of an offline processor core according to some embodiments. In the embodiments of FIG. 2A and FIG. 2B, the multicore processor system 100 includes n physical processor cores (denoted as P0 to P(n-1)) and an emulated processor core 230 (denoted as Pn). In addition to the software modules 111-116 shown in FIG. 1, the OS kernel 150 may further include a DVFS driver 211 and an alias manager 212. The DVFS driver 211 adjusts the operating frequency and voltage of each processor core based on power and performance requirements. The alias manager 212 creates an alias for a processor core (e.g., P0) when the processor core goes offline, and removes that alias when the processor core is back online. In the embodiment shown in FIG. 2A, the alias may identify an online processor core (e.g., P1). One example of the alias is a symbolic link, which may link the file system (e.g., sysfs) of P0 to the file system of an online processor core.

Alternatively, in the embodiment of FIG. 2B, the alias may identify the emulated processor core 230 (i.e., Pn), which serves as a substitute for an offline processor core. The emulated processor core 230 is not a physical processor core. Rather, it is a software construct containing an emulated state 235 of the offline processor core. Thus, when P0 goes offline, its operating parameters (e.g., operating frequency and voltage) may be copied to the emulated state 235 maintained by Pn. In one embodiment, the emulated state 235 may include emulated operating frequency and voltage of the offline processor core P0. When P0 is back online, the emulated state 235 is copied from Pn back to the P0.

Thus, when the DVFS driver 211 commands an offline processor core (e.g., P0) to adjust its operating parameters such as the frequency or voltage, the mapped processor core (P1 in FIG. 2A or Pn in FIG. 2B) can serve as a substitute for P0 to undertake the adjustment of the operating parameters. The adjustment can be performed by the mapped processor core until PO is back online. If the emulated processor core Pn is selected as the mapped processor core, Pn may emulate the adjustment to the operating parameters of P0 in response to the command of the DVFS driver 211 until P0 is back online. When P0 is back online, the operating parameters of P0 can be adjusted according to the final operating parameters of the mapped processor core. Moreover, when P0 is offline and a user space application inquires P0 about system information, the system information may be retrieved from the corresponding file system of the mapped processor core (P1 in FIG. 2A or Pn in FIG. 2B).

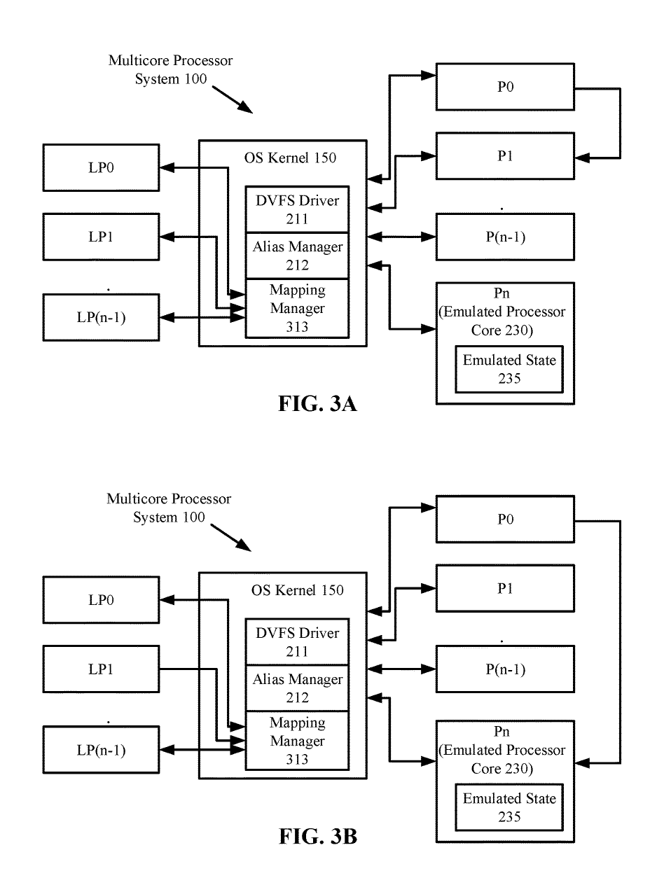

FIG. 3A and FIG. 3B illustrate two additional mappings of an offline processor core according to some embodiments. In addition to the software modules shown in FIG. 1, FIG. 2A and FIG. 2B, the OS kernel 150 further includes a mapping manager 313 that manages the mapping between logical processor cores and physical processor cores. For example, the logical processor core (LP0) may be mapped by the mapping manager 313 to the physical processor core (P0). A task scheduler may assign tasks to LP0 and it is P0 that performs the actual execution of the tasks.

As shown in FIG. 3A, when P0 goes offline, the alias manager 212 may create an alias for P0 to point to an online processor core such as P1. Thus, LP0 is effectively mapped to P1. As mentioned before, one example of the alias is a symbolic link, which may link the file system (e.g., sysfs) of P0 to the file system of P1.

In another embodiment of FIG. 3B, the alias may identify the emulated processor core 230 (i.e., Pn). Thus, LP0 is effectively mapped to Pn. When P0 goes offline, its operating parameters (e.g., operating frequency and voltage) may be copied to the emulated state 235 maintained by Pn. In one embodiment, the emulated state 235 may include emulated operating frequency and voltage of the offline processor core P0. When P0 is back online, the emulated state 235 is copied from Pn back to the P0.

When the DVFS driver 211 commands LP0 to change its operating frequency, the mapped processor core (P1 in FIG. 3A or Pn in FIG. 3B) can serve as a substitute for P0 to undertake the adjustment of the operating parameters. The adjustment can be performed by the mapped processor core until P0 is back online. If the emulated processor core Pn is selected as the mapped processor core, Pn may emulate the adjustment to the operating parameters of P0 in response to the command of the DVFS driver 211 until P0 is back online. When P0 is back online, its operating parameters can be adjusted according to the final operating parameters of the mapped processor core. Moreover, when a user space application inquires LP0 about system information, the system information may be retrieved from the corresponding file system of the mapped processor core (P1 in FIG. 3A or Pn in FIG. 3B).

Although P0 is used as an example of an offline processor core, it should be understood that the embodiments described hereinafter are applicable to any of the processor cores in a multicore processor system.

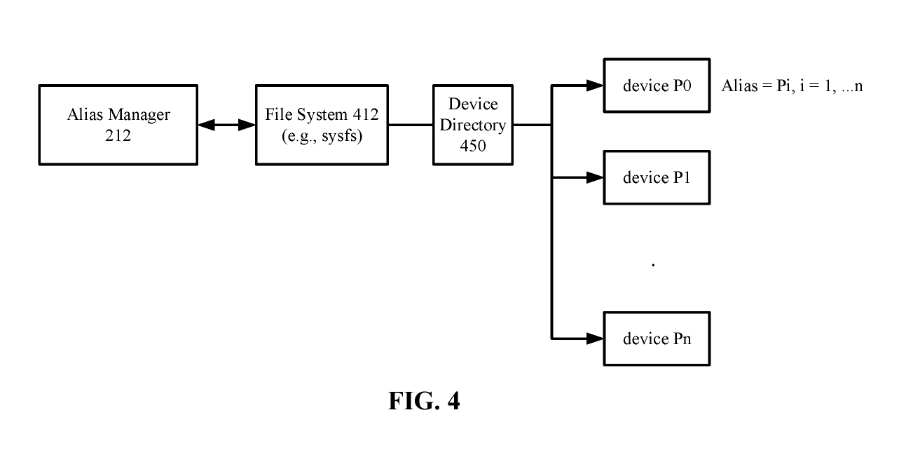

FIG. 4 illustrates further details of the alias manager 212 according to one embodiment. Each processor core, including the emulated processor core, is associated with a software construct that contains a set of data structures holding its file system. More specifically for the emulated processor core, the emulated processor core is a software construct that contains a set of data structures holding at least partially the file system of at least one offline processor core. In one embodiment, a processor core may go offline and its file system may contain a pointer pointing the file system of a mapped processor core, where the mapped processor core is an online processor core or the emulated processor core. In one embodiment, the mapped processor core is an active processor core or the emulated processor core.

To manage the mapping between the processor cores, the alias manager 212 maps files in a file system 412 (e.g., sysfs) between the corresponding processor cores. The file system 412 includes a collection of data structures, which further include a device directory 450. Under the device directory 450, each processor core (including the emulated processor core Pn) is associated with a device file; e.g., “device P0” for processor core P0, “device P1” for processor core P1, etc. Each of these device files records the operating parameters of the corresponding processor core, including but not limited to the operating frequency and the operating voltage of the corresponding processor core. When P0 goes offline, the pointer pointing to “device P0” may be aliased or linked to another device file such as “device Pi”, where i=1, n. In one embodiment, a symbolic link may be created to link “device P0” to “device Pi.” The alias or the symbolic link allow a query to “device P0” to be re-directed to “device Pi.” Thus, when an adjustment is made to the operating parameters of an offline processor core (e.g., P0), the device file associated with the mapped processor core (Pi) records the adjustment until P0 goes back online. When P0 is back online, the alias or the symbolic link is removed.

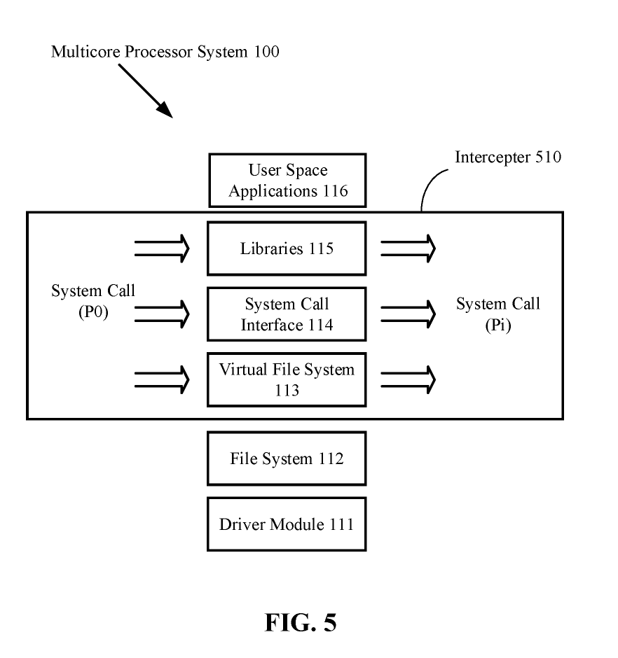

FIG. 5 illustrates a mechanism for intercepting a system call to an offline processor core according to one embodiment. In this embodiment, the multicore processor system 100 further includes an interceptor 510 that intercepts system calls made by a requestor that requests for system information. The requestor may be a software module, such as the virtual file system 113, system call interface 114, the libraries 115, or other software modules executed by the multicore processor system 100. In one embodiment, the request for system information may be made to the file system (e.g., sysfs) of an offline processor core (e.g., P0). After the interceptor 510 intercepts the request, it re-directs the system call to another processor core (e.g., Pi, where i =1, n), which may be an online processor core or an emulated processor core.

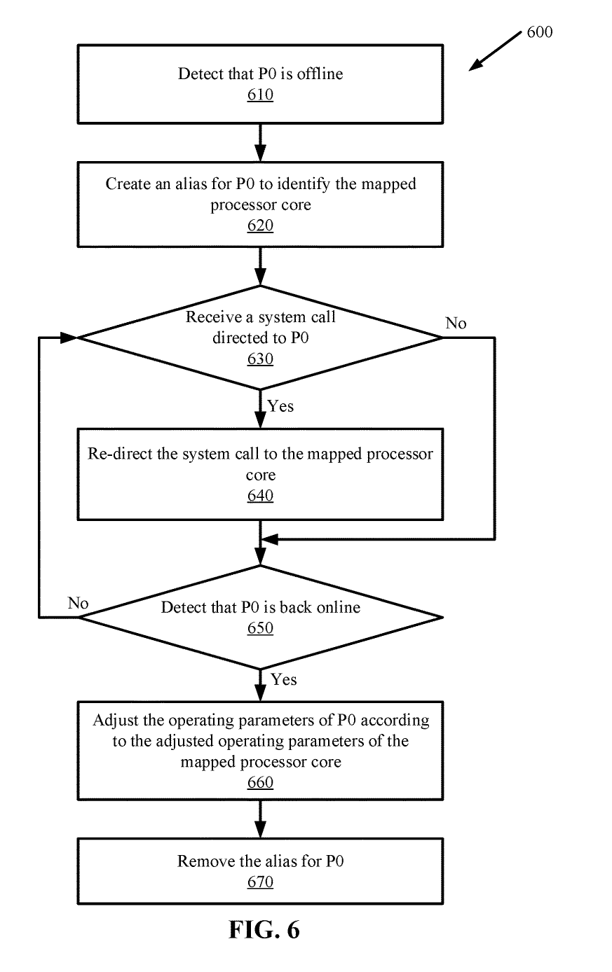

FIG. 6 is a flow diagram illustrating a method 600 for managing an alias of an offline processor core according to one embodiment. In one embodiment, the method 600 may be performed by the OS kernel 150 of FIG. 1. The OS kernel 150 detects that a processor core (e.g., P0) is offline at step 610. An alias for P0 is created at step 620, where the alias identify a mapped processor core. For example, the alias may be Pi, where i =1, . . . , (n-1) represents a physical processor core and i=n represents an emulated processor core. In one embodiment, the alias of P0 may identify an online processor core or the emulated processor core. In one embodiment, the alias may be created as a symbolic link that maps or links P0 to the mapped processor core. If a system call to P0 is received at step 630, the system call is re-directed to the mapped processor core (i.e., Pi) at step 640. The steps 630 and 640 repeat until P0 is back online at step 650. When P0 is back online at step 650, the operating parameters of P0 is adjusted at step 660 according to the adjusted operating parameters of the mapped processor core, if any adjustment was made during the time period when P0 was offline. Then the alias (or the symbolic link) is removed from P0 at step 670.

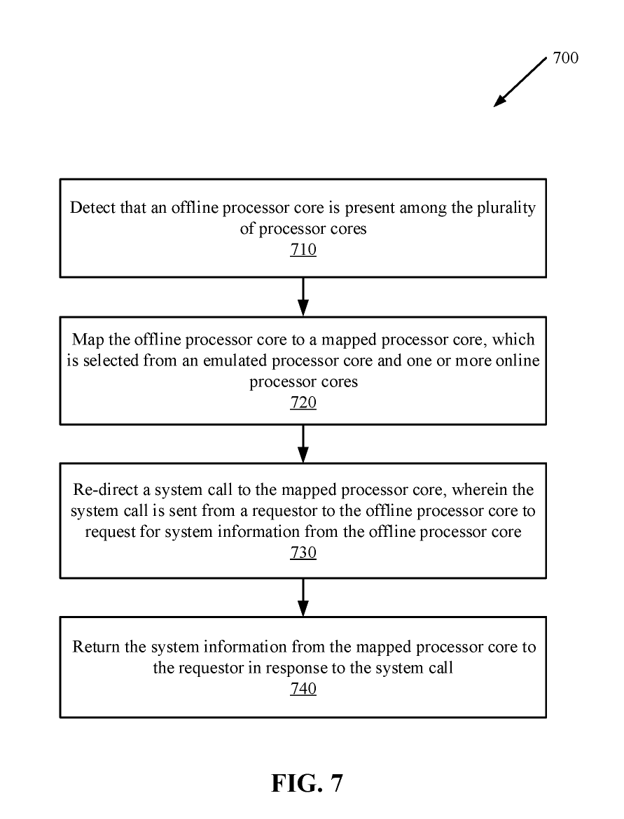

FIG. 7 is a flow diagram illustrating a method 700 for mapping an offline processor cores according to one embodiment. The method 700 may be performed by hardware (e.g., circuitry, dedicated logic, programmable logic, microcode, etc.), software (e.g., instructions run on a processing device), firmware, or a combination thereof. In one embodiment, the method 700 may be performed by a system, such as the multicore processor system 100 of FIG. 1; more specifically, the method 700 may be performed by the OS kernel 150 of FIG. 1 executed by the multicore processor system 100. The system that performs the method 700 includes a plurality of processor cores. In one embodiment, the plurality of processor cores further includes one or more online processor cores.

In one embodiment, the method 700 begins when the system detects that an offline processor core is present among the plurality of processor cores (step 710). The system maps the offline processor core to a mapped processor core, which is selected from an emulated processor core and the one or more online processor cores (step 720). The emulated processor core is a software construct containing an emulated state of the offline processor core. When the system receives a system call that is sent from a requestor to the offline processor core to request for system information from the offline processor core, the system re-directs that system call to the mapped processor core (step 730). The system then returns the system information from the mapped processor core to the requestor in response to the system call (step 740).

In one embodiment, the online processor core that is selected as the mapped processor core is a processor core that has power consumption characteristics and/or computation performance closest to the offline processor core. Alternatively, the mapped processor core may be a processor core having any power consumption characteristics and computation performance. In one embodiment, the system call may include an inquiry about an operating frequency of the offline processor core, and the mapped processor core returns its operating frequency (if the mapped processor core is an online processor core) or an emulated operating frequency (if the mapped processor core is an emulated processor core). In another embodiment, the system call may include a command to adjust the operating frequency of the offline processor core, and the mapped processor core responds by adjusting its operating frequency (if the mapped processor core is an online processor core) or an emulated operating frequency (if the mapped processor core is an emulated processor core).

The operations of the flow diagrams of FIGS. 6 and 7 have been described with reference to the exemplary embodiments of FIGS. 1-5. However, it should be understood that the operations of the flow diagrams of FIGS. 6 and 7 can be performed by embodiments of the invention other than those discussed with reference to FIGS. 1-5, and the embodiments discussed with reference to FIGS. 1-5 can perform operations different than those discussed with reference to the flow diagrams. While the flow diagrams of FIGS. 6 and 7 show a particular order of operations performed by certain embodiments of the invention, it should be understood that such order is exemplary (e.g., alternative embodiments may perform the operations in a different order, combine certain operations, overlap certain operations, etc.).

Various functional components or blocks have been described herein. As will be appreciated by persons skilled in the art, the functional blocks will preferably be implemented through circuits (either dedicated circuits, or general purpose circuits, which operate under the control of one or more processors and coded instructions), which will typically comprise transistors that are configured in such a way as to control the operation of the circuity in accordance with the functions and operations described herein. The specific structure or interconnections of the transistors may be determined by a compiler, such as a register transfer language (RTL) compiler. RTL compilers operate upon scripts that closely resemble assembly language code, to compile the script into a form that is used for the layout or fabrication of the ultimate circuitry. RTL is well known for its role and use in the facilitation of the design process of electronic and digital systems.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method of a multicore processor system that includes a plurality of processor cores, comprising:
detecting that an offline processor core is present among the plurality of processor cores;
mapping the offline processor core to a mapped processor core, which is selected from an emulated processor core and one or more online processor cores among the plurality of processor cores, wherein the emulated processor core is a software construct containing an emulated state of the offline processor core;
re-directing a system call to the mapped processor core, wherein the system call is sent from a requestor to the offline processor core to request for system information from the offline processor core; and
returning the system information from the mapped processor core to the requestor in response to the system call.

2. The method of claim 1, wherein, when mapping the offline processor core, the method further comprises:
creating an alias for the offline processor core, wherein the alias identifies the mapped processor core.

3. The method of claim 1, wherein, when mapping the offline processor core, the method further comprises:
creating a symbolic link from the offline processor core to the mapped processor core.

4. The method of claim 1, wherein receiving the system call further comprises:
intercepting the system call made by a software module acting as the requester, wherein the software module is one of: a standard library, a system call interface and a virtual file system.

5. The method of claim 1, wherein the system call includes an inquiry about an operating frequency of the offline processor core.

6. The method of claim 1, wherein the system call includes a command to adjust an operating frequency of the offline processor core.

7. The method of claim 6, wherein, when the emulated processor core is selected as the mapped processor core, the method further comprises:
emulating an adjustment to the current operating frequency of the offline processor core; and
recording the adjustment in a data structure of the emulated processor core.

8. The method of claim 1, wherein, when mapping the offline processor core, the method further comprises:
selecting one of the online processor cores that has power consumption characteristics and computation performance closest to the offline processor core.

9. The method of claim 1, further comprising:
detecting that the offline processor core is back online; and
removing a symbolic link or an alias that maps the offline processor core to the mapped processor core.

10. The method of claim 1, further comprising:
detecting that the offline processor core is back online; and
copying the emulated state of the offline processor core from the mapped processor core to the offline processor core.

11. A system comprising a plurality of processor cores and memory, the memory containing instructions executable by the plurality of processor cores, wherein the system is operative to:
detect that an offline processor core is present among the plurality of processor cores;
map the offline processor core to a mapped processor core, which is selected from an emulated processor core and one or more online processor cores among the plurality of processor cores, wherein the emulated processor core is a software construct containing an emulated state of the offline processor core;
re-direct a system call to the mapped processor core, wherein the system call is sent from a requestor to the offline processor core to request for system information from the offline processor core; and
return the system information from the mapped processor core to the requestor in response to the system call.

12. The system of claim 11, wherein, when mapping the offline processor core, the system is further operative to create an alias for the offline processor core, wherein the alias identifies the mapped processor core.

13. The system of claim 11, wherein, when mapping the offline processor core, the system is further operative to create a symbolic link from the offline processor core to the mapped processor core.

14. The system of claim 11, wherein the system call is made by a software module acting as the requester, wherein the software module is one of: a standard library, a system call interface and a virtual file system.

15. The system of claim 11, wherein the system call includes an inquiry about an operating frequency of the offline processor core.

16. The system of claim 11, wherein the system call includes a command to adjust an operating frequency of the offline processor core.

17. The system of claim 16, wherein, when the emulated processor core is selected as the mapped processor core, the system is further operative to: emulate an adjustment to the current operating frequency of the offline processor core, and record the adjustment in a data structure of the emulated processor core.

18. The system of claim 11, wherein, when mapping the offline processor core, the system is further operative to select one of the online processor cores that has power consumption characteristics and computation performance closest to the offline processor core.

19. The system of claim 11, wherein, when the offline processor core is back online, the system is further operative to remove a symbolic link or an alias that maps the offline processor core to the mapped processor core.

20. The system of claim 11, wherein, when the offline processor core is back online, the system is further operative to copy the emulated state of the offline processor core from the mapped processor core to the offline processor core.
